(19) United States
(12) Patent Application Publication
(10) Pub. No.: US 2016/0239161 A1
(43) Pub. Date: Aug. 18, 2016

(54) METHOD AND SYSTEM FOR TERM-OCCURRENCE-BASED NAVIGATION OF APPORTIONED E-BOOK CONTENT

(71) Applicant: Kobo Incorporated, Toronto (CA)

(72) Inventor: Inae HEO, North York (CA)

(73) Assignee: KOBO INCORPORATED, Toronto (CA)

(21) Appl. No.: 14/621,034

(22) Filed: Feb. 12, 2015

(51) Int. Cl. G06F 3/0482; G06F 17/27; G06F 3/0488; G06F 3/0483; G06F 3/0484

(52) U.S. Cl. CPC G06F 3/0482; G06F 3/0483; G06F 3/04842; G06F 3/0488; G06F 17/277

(57) ABSTRACT

A method and system for term-occurrence-based navigation of content apportionments of an e-book. The method comprises receiving a term occurrence search request at a text portion of the e-book content, the text portion comprising the term and the content of the e-book is apportioned according to a plurality of content apportionments, determining a frequency of occurrence of the term within respective ones of the content apportionments, rendering a frequency indicator of the frequency of occurrence associated with the respective ones of the content apportionments at the display screen, receiving, at the display screen, a navigation request for transitioning to a selected one of the content apportionments of e-book content, and displaying a summary list of term occurrence content excerpts from the selected content apportionment.

### TECHNICAL FIELD

Examples described herein relate to a system and method for operating a computing device to provide term-occurrence-based navigation of content apportionments of an e-book for digital reading (e-reading).

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

Yet further, such devices may incorporate a touch screen display having integrated touch sensors and touch sensing functionality, whereby user input commands via touch-based gestures are received thereon.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device configured for operation of a term-occurrence-based navigation of content apportionments of an e-book, in an embodiment.

FIG. 2 illustrates a schematic architecture and configuration of a computing device configured for term-occurrence-based navigation of content apportionments of an e-book displayed on a touchscreen display of the computing device, according to an embodiment.

FIGS. 3A-3E illustrate example configurations of a term-occurrence-based navigation of content apportionments of an e-book, according to some embodiments.

FIG. 4 illustrates a method for providing term-occurrence-based navigation of content apportionments of an e-book, according to an embodiment.

### DETAILED DESCRIPTION

“E-books” are a form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, tier example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

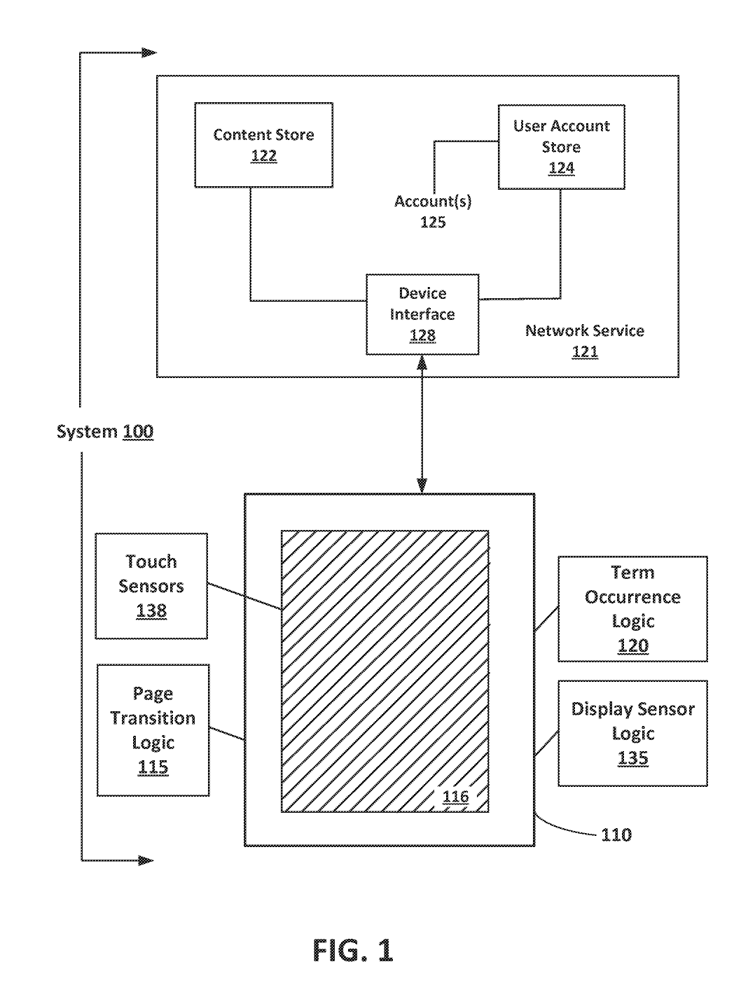

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 121. The network service 121 can include multiple servers and other computing resources that provide various services in connection with one or more applications that are installed on thee-reading device 110. By way of example, in one implementation, the network service 121 can provide e-book services that communicate with the e-reading device 110. The e-book services provided through network service 121 can, for example, include services in which e-books are sold, shared, downloaded and/or stored. More generally, the network service 121 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 121 and enables e-books provided through the service to be viewed and consumed. In another implementation, the e-reading device 110 can run a media playback or streaming application that receives files or streaming data from the network service 121. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 121 can include a device interface 128, a content store 122 and a user account store 124. The user account store 124 can associate the e-reading device 110 with a user and with an account 125. The account 125 can also be associated with one or more application resources (e.g., e-books), which can be stored in the content store 122. The device interface 128 can handle requests from the e-reading device 110, and further also requests of e-reading device 110 with regard to services and functionality of the network service 121. The device interface 128 can utilize information provided with a user account 125 in order to enable services, such as purchasing downloads or determining what e-books and content items are associated with e-reading device 110. Additionally, the device interface 128 can provide the e-reading device 110 with access to the content store 122, which can include, for example, an online store. The device interface 128 can handle input to identify content items e.g., e-books), and further to link content items to the account 125 of the user.

Yet further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources e.g., e-books) that are purchased or otherwise made available to the user of the e-reading device 110, as well as to archive e-books and other digital content items that have been purchased for the user account 125, but are not stored on a particular computing device.

With reference to an example of FIG. 1, e-reading device 110 can include a display screen 116. In an embodiment, the display screen 116 is touch-sensitive, to process touch inputs including gestures (e.g., swipes). For example, the display screen 116 may be integrated with one or more touch sensors 138 to provide a touch-sensing region on a surface of the display screen 116. For some embodiments, the one or more touch sensors 138 may include capacitive sensors that can sense or detect a human body's capacitance as input. In the example of FIG. 1, the touch-sensing region coincides with a substantial surface area, if not all, of the display screen 116. Additionally, the housing can be integrated with touch sensors to provide one or more touch sensing regions, for example, on the bezel and/or back surface of the housing.

In some embodiments, the e-reading device 110 includes features for providing functionality related to displaying paginated content, including paginated content for an e-book, or in variations of an e-book including an e-magazine or e-comic book. The e-reading device 110 can include page transition logic 115, which enables the user to transition through paginated content. The e-reading device 110 can display pages of e-books, e-magazines and e-comics, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In the specific example embodiment where a given page state coincides with a single page, for instance, each page state corresponding to one page of the digitally constructed series of pages paginated to comprise, in one embodiment, an e-book. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch-sensing region of the display screen 116. For example, the user may swipe the surface of the display screen 116 in a particular direction (e.g., up, down, left, or right) to indicate a backward or forward direction of page transition. In variations, the user can specify different kinds of page transitioning input (e.g., single page turns, multiple page turns, chapter turns, etc.) through different kinds of input. Additionally, a page turn input of the user can be provided according to a magnitude of the input action indicate a corresponding magnitude (number of pages) for the transition of the page state. For example, a user can touch and hold the surface of the display screen 116 in order to cause a cluster or chapter page state transition, while a tap in the same region can only effect a single page state transition (e.g., from one page to the next in sequence). In another example, a user can specify page turns of different kinds or magnitudes through single taps, sequenced taps or patterned taps on the touch sensing region of the display screen 116. Although discussed in context of “taps” herein, it is contemplated that a gesture action provided in sufficient proximity to touch sensors of display screen 116, without physically touching thereon, may also register as a “contact” with display screen 116, to accomplish a similar effect as a tap, and such embodiments are also encompassed by the description herein.

According to some embodiments, the e-reading device 110 includes display sensor logic 135 to detect and interpret user input or user input commands made through interaction with the touch sensors 138. By way of example, display sensor logic 135 can detect a user making contact with the touch-sensing region of the display screen 116, otherwise known as a touch event. More specifically, display sensor logic 135 can detect a touch events also referred to herein as a tap, an initial tap held in contact with display screen 116 for longer than some pre-defined threshold duration of time (otherwise known as a “long press” or a “long touch”), multiple taps performed either sequentially or generally simultaneously, swiping gesture actions made through user interaction with the touch sensing region of the display screen 116, or any combination of these gesture actions. Although referred to herein as a “touch” or a tap, it should be appreciated that in some design implementations, sufficient proximity to the screen surface, even without actual physical contact, may register a “contact” or a “touch event”. Furthermore, display sensor logic 135 can interpret such interactions in a variety of ways. For example, each such interaction may be interpreted as a particular type of user input associated with a respective input command, execution of which may trigger a change in state of display 116.

In one implementation, display sensor logic 135 implements operations to monitor for the user contacting or superimposing upon, using a finger, thumb or stylus, a surface of display 116 coinciding with a placement of one or more touch sensor components 138, that is, a touch event, and also detects and correlates a particular gesture (e.g., pinching, swiping, tapping, etc.) as a particular type of input or user action. Display sensor logic 135 may also sense directionality of a user gesture action so as to distinguish between, for example, leftward, rightward, upward, downward and diagonal swipes along a surface portion of display screen 116 for the purpose of associating respective input commands therewith.

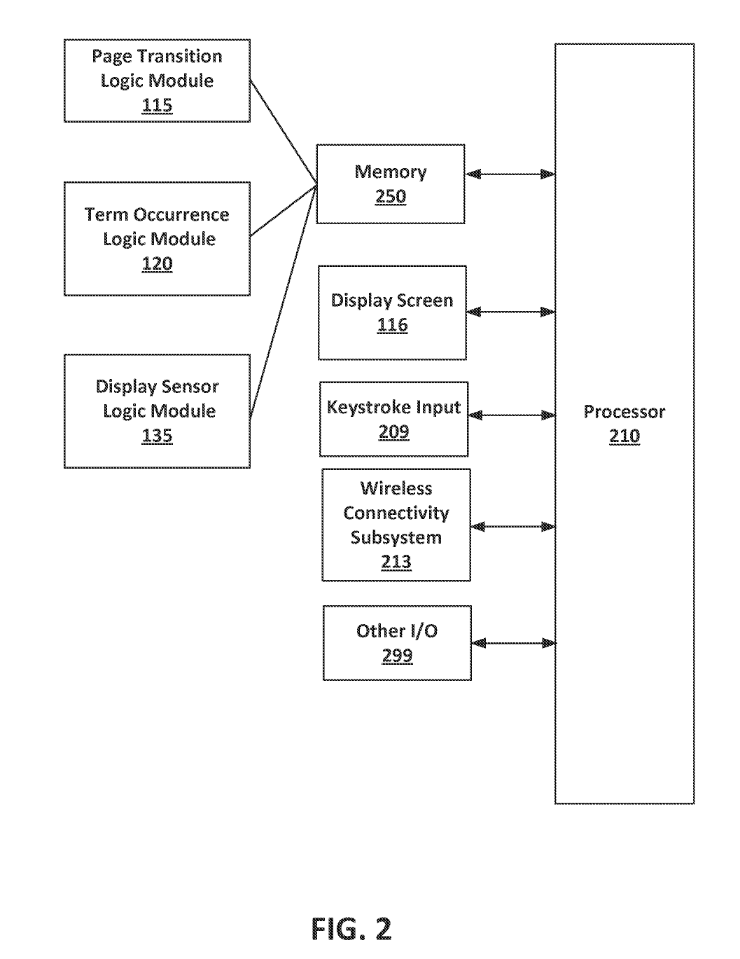

Term occurrence logic module 120 can be implemented as a software module comprising instructions stored in a memory of mobile computing device 110, as described in further detail below with regard to FIG. 2.

One or more embodiments of term occurrence logic module 120, display sensor logic 135 and page transition logic 115 described herein may be implemented using programmatic modules or components. A programmatic module or component may include a program, a subroutine, a portion of a program, or a software or a hardware component capable of performing one or more stated tasks or functions in conjunction with one or more processors. As used herein, a module or component can exist on a hardware component independently of other modules or components. Alternatively, a module or component can be a shared element or process of other modules, programs and hardware components.

Furthermore, the one or more embodiments of term occurrence logic module 120, display sensor logic 135 and page transition logic 115 described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid-state memory (such as included on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

FIG. 2 illustrates a schematic architecture and configuration of a computing device configured for providing term-occurrence-based navigation of content apportionments of an e-book on a touchsereen display of the computing device, according to an embodiment.

E-reading device 110 further includes processor 210, a memory 250 storing instructions and logic pertaining at least to display sensor logic 135, term occurrence logic module 120, and page transition logic 115.

Processor 210 can implement functionality using the logic and instructions stored in memory 250. Additionally, in some implementations, processor 210 communicates with the network service 121 (see FIG. 1). More specifically, the e-reading device 110 can access the network service 121 to receive various kinds of resources (e.g., digital content items such as e-books, configuration files, account information), as well as to provide information (e.g., user account information, service requests etc.). For example, e-reading device 110 can receive application resources, such as e-books or media files, that the user elects to purchase or otherwise download via the network service 121. The application resources that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can receive input from various sources, including touch sensor components 138, display 116, keystroke input 209 such as from a virtual or rendered keyboard, and other input mechanisms 299 (e.g., buttons, mouse, microphone, etc.). With reference to examples described herein, processor 210 can respond to input detected at the touch sensor components 138. In some embodiments, processor 210 responds to inputs from the touch sensor components 138 in order to facilitate or enhance e-book activities such as generating e-book content on display 116, performing page transitions of the displayed e-book content, powering off e-reading device 110 and/or display 116, activating a screen saver, launching or closing an application, and/or otherwise altering a state of display 116.

In some embodiments, memory 250 may store display sensor logic 135 that monitors for user interactions detected through the touch sensor components 138, and further processes the user interactions as a particular input or type of input. In an alternative embodiment, display sensor logic module 135 may be integrated with the touch sensor components 138. For example, the touch sensor components 138 can be provided as a modular component that includes integrated circuits or other hardware logic, and such resources can provide some or all of display sensor logic 135. In variations, some or all of display sensor logic 135 may be implemented with processor 210 (which utilizes instructions stored in memory 250), or with an alternative processing resource.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which computing device 110 is intended to operate, such as in accordance with Wi-Fi, Bluetooth, Near Field Communication (NFC) communication protocols, and the like.

Term occurrence logic module 120, in one embodiment, enables a user to locate occurrences of any given term in the digital content comprising the e-book, among other functions as described below. A corresponding term search operation with regard to a conventional paper book or textbook may be initiated at an index section, typically located towards the end of the work, whereupon a user searches terms alphabetically, notes the term occurrence page numbers, then flips pages to view each page individually. The digital structure of an e-book, wherein pages are constructed of digitally stored text, may allow manipulation of e-book text terms comprising the content in other ways, however.

Term occurrence logic module 120 can be implemented as a software module, comprising instructions stored in memory 250, on mobile computing device 110. One or more embodiments of logic module 120 described herein may be implemented using programmatic modules or components, a portion of a program, or software in conjunction with one or more hardware component(s) capable of performing one or more stated tasks or functions. As used herein, such module or component can exist on a hardware component independently of other modules or components. Alternatively, a module or component can be a shared element or process of other modules, programs or machines.

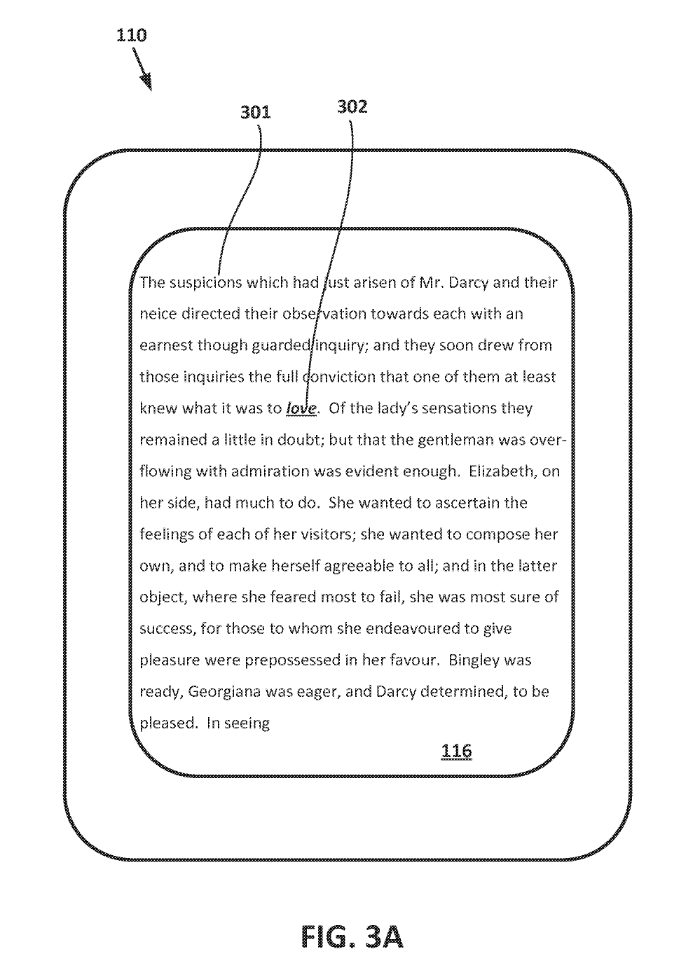

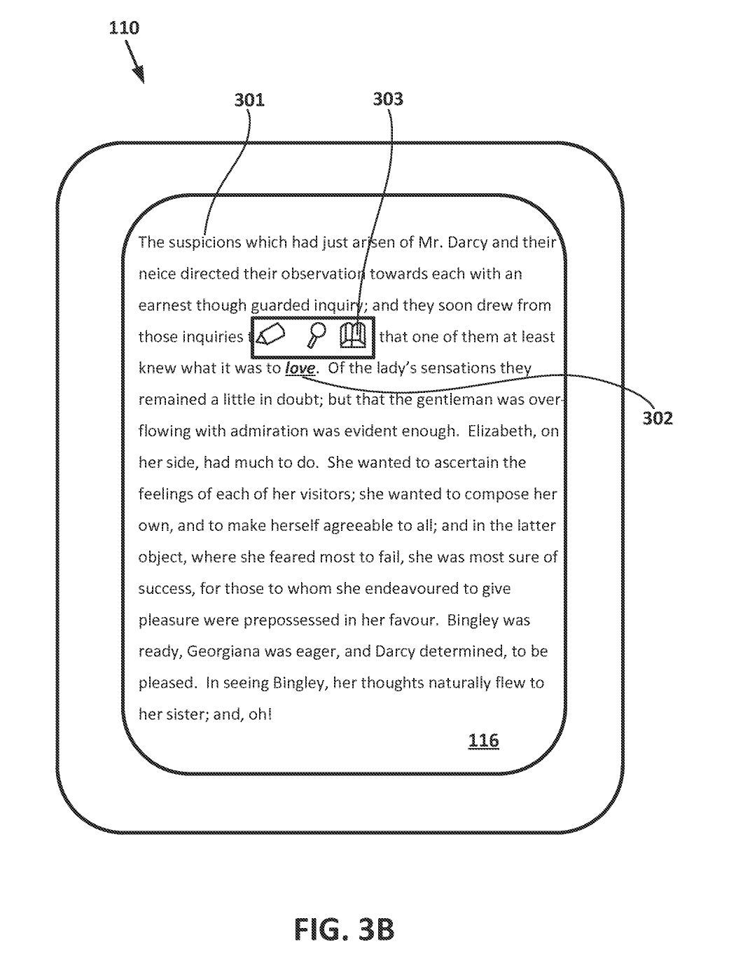

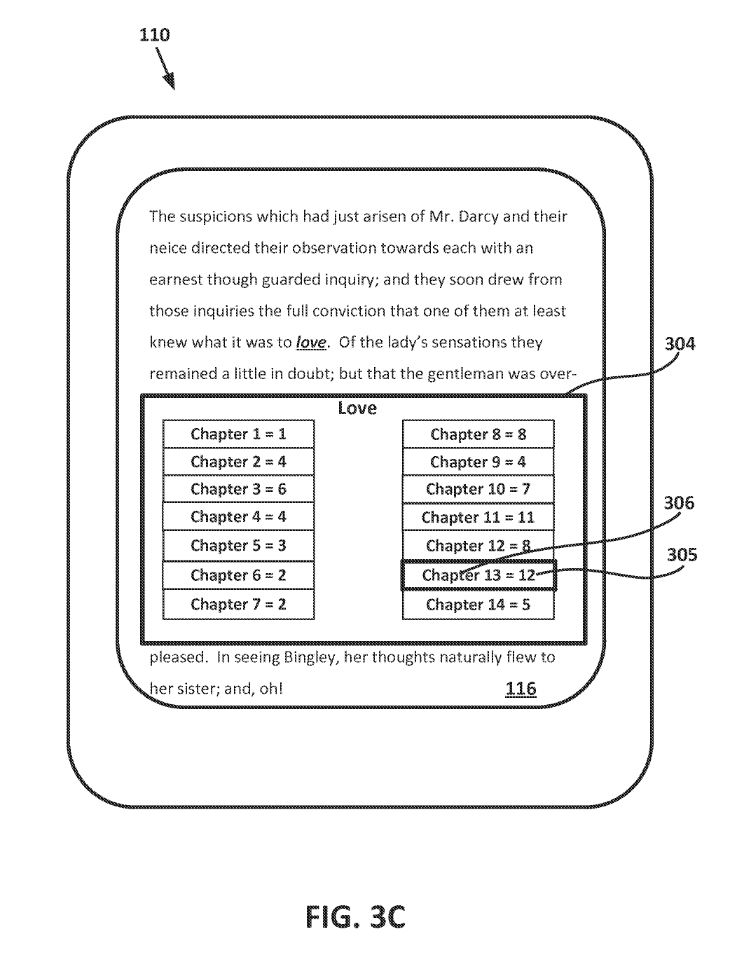

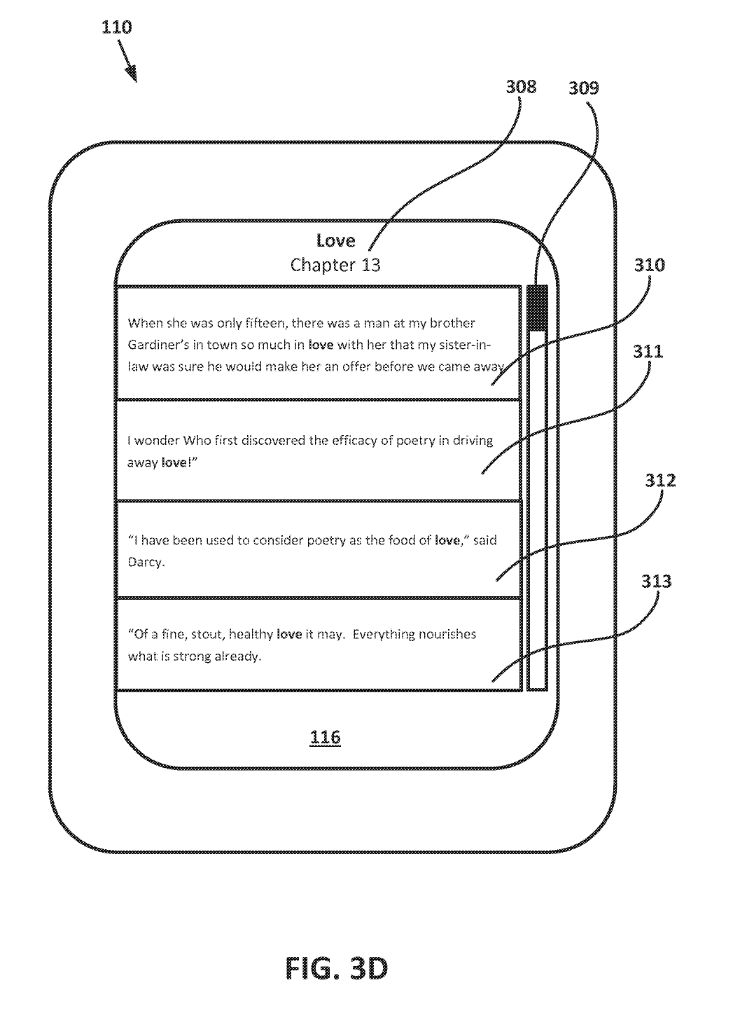

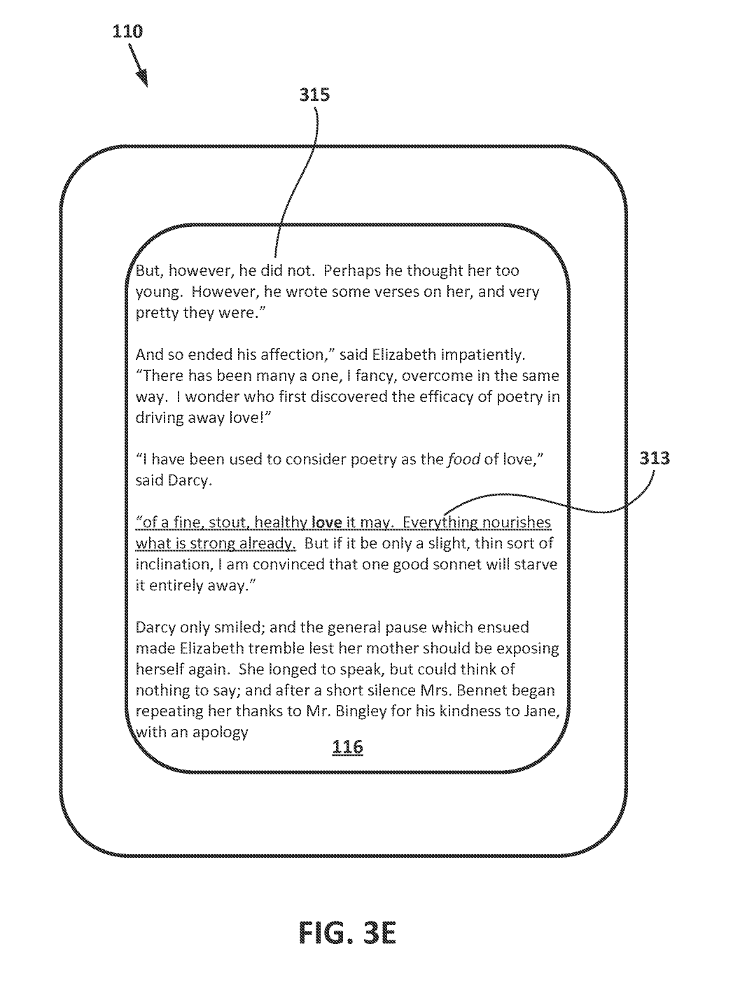

FIG. 3 illustrates an example embodiment for a term-occurrence-based navigation of content apportionments of an e-book on a computer device having a touchscreen display, particularly in regard to operation of term occurrence logic module 120.

in prelude to the depiction of FIG. 3, and with regard to content of a page in the ordered sequence of pages comprising an e-book, a search request may be initiated by selection of any text term at any given page, including but not limited to an index page. In one embodiment, a touch action or gesture may be received at the term, such as a long press, a term highlight action followed by a menu option icon selection or command.

FIG. 3A shows current page content 301, by way of illustration, with a term “love” 302 occurring within the page. The term “love” 302 is selectable for a comprehensive search across the paginated content of the e-book for occurrences therein. Pages of the e-book may be clustered or apportioned according to chapter designations, book part or book segment designations, and the like.

Now with reference to 313, the searched term “love” 302 may be selected for searching via a touch action or gesture received at the term, such as a long press, or by a term highlighting action followed by a menu option icon selection 303 or like command. The searched term “love” 302 may be rendered within term occurrence page content 301 in a visually distinct manner from other content therein, such as bold or italics typeface, color, or via highlighting or variation in illumination, in some embodiments. In another embodiment, a user may specify a threshold number of term occurrences upon which the search may be based, whereby only e-book chapters that include the threshold number or more occurrences of the term “love” will be located for display.

Next with reference to FIG. 3C, term occurrence logic module 120 may identify and determine a frequency of occurrences 305 of searched term “love” 302 across all pages of the e-book, then render results for frequency of occurrences 305 via a frequency indicator according to a respective chapter, or alternate content apportionment 306 of the e-book, within occurrence frequency interface 304 at display screen 116 of computing device 110. In one embodiment, the frequency indicator may be a number of occurrences 305 of the searched term “love” 302 in a respective chapter of the e-book. In other embodiments, the frequency indicator may be a qualitative indicator, such as various colors, representing a high, medium and low number of occurrences, for example.

Next as depicted in FIG. 3D, in response to a navigation request enacted upon frequency indicator interface 304, a user may transition to a view showing term occurrence content excerpts 310-313 of content apportionment 306 (“Chapter 13”), for presentation on display screen 116. In the example depiction of FIG. 3D, since term occurrence content excerpts 310-313 represent only a first few of term occurrence content portions within Chapter 13, it is contemplated that the remaining content excerpts therein may be viewed, in order of their occurrences within Chapter 13 by scrolling downwards, such as by applying scroll indicator 309.

Notably, and now with reference to FIG. 3E, a user may choose to navigate to a larger amount of e-book content immediately surrounding any of a selected one of term occurrence content excerpts 310-313. In an example depiction of FIG. 3E, selecting term occurrence content excerpt 313 for navigation results in a display of e-book display page 315 including content immediately surrounding content excerpt 313. In one embodiment, content excerpt 313 may be arranged on display page 315 with content immediately preceding and following, with content excerpt 313 generally centered therebetween and shown in a visually distinct manner from surrounding content of display page 315.

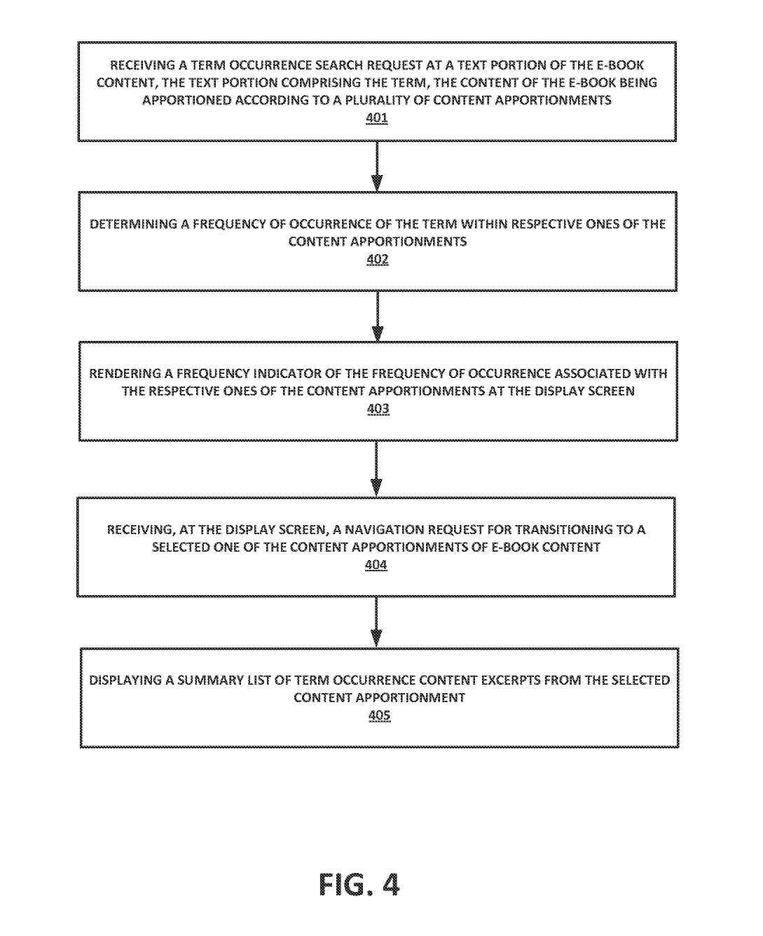

Next with reference to FIG, 4, illustrated is a method for providing a term-occurrence-based navigation of content apportionments of an e-book on computer device 110 having touchscreen display 116, according to an embodiment. In describing the example of FIG. 4, reference will be made to components such as described with regard to FIG. 1 through FIGS. 3A-3E for purposes of illustrating components for performing a step or sub-step as described.

At step 401, receiving a term occurrence search request at a text portion 302 of the e-book content, the text portion comprising the term, the content of the e-book being apportioned according to a plurality of content apportionments, the text portion comprising the term “love” 302, In the case of an e-book, the content apportionments may be according to chapter designations of content of the e-book. For an e-magazine, the content apportionments may be according to individual or discrete article sections or topics comprising content of the e-book.

At step 402, determining a frequency of occurrence 305 of the term within respective ones of the content apportionments of the e-book.

At step 403, rendering a frequency indicator of the frequency of occurrence 305 associated with the respective ones of the content apportionments at the display screen 116.

At step 404, receiving, at the display screen 116, a navigation request for transitioning to a selected one of the content apportionments 306 of e-book content.

At step 405, displaying a summary list 308 of term occurrence content excerpts 310-313 from the selected content apportionment 306.

Although illustrative embodiments have been described in detail herein with reference to the accompanying drawings, variations to specific embodiments and details are contemplated and encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor from claiming rights to such combinations.

What is claimed is:

1. A method executed in a processor of a computing device, the computing device, further including a display screen having touch functionality and a memory storing instructions and an e-book, the e-book having content arranged in an ordered sequence of digitally constructed pages, the method comprising:
receiving a term occurrence search request at a text portion of the e-book content, the text portion comprising the term, the content of the e-book being apportioned according to a plurality of content apportionments;
determining a frequency of occurrence of the term within respective ones of the content apportionments;
rendering a frequency indicator of the frequency of occurrence associated with the respective ones of the content apportionments at the display screen;
receiving, at the display screen, a navigation request for transitioning to a selected one of the content apportionments of e-book content; and
displaying a summary list of term occurrence content excerpts from the selected content apportionment.

2. The method of claim 1 wherein the term occurrence content excerpts are selectable within the summary list.

3. The method of claim 2 further comprising:
receiving a selection of a respective one of the term occurrence content excerpts from the summary list; and
rendering the selected term occurrence content excerpt arranged intermediate an antecedent content portion and a subsequent content portion of the content apportionment.

4. The method of claim 1 wherein the term occurrence search request comprises a long press touch gesture enacted upon the term on the display screen.

5. The method of claim 1 wherein the term occurrence search request comprises a highlighting action performed upon the term followed by a selection of a menu icon option.

6. The method of claim 1 wherein the respective ones of the content apportionments comprise apportioned chapters of the e-book.

7. The method of claim 1 wherein the e-book is an e-magazine.

8. The method of claim 7 wherein the respective ones of the content apportionments comprise apportioned e-magazine articles.

9. The method of claim 1 wherein the summary list is scrollable to show the content excerpts in order of occurrence within the selected content apportionment.

10. The method of claim 1 wherein the term is rendered visually distinctly within at least one of the summary list and the selected content apportionment.

11. A computer-readable medium that stores instructions for a computing device, the computing device including a processor, a memory and a display screen having touch functionality, the display screen rendering an e-book content including text formatted in an ordered sequence of digitally constructed pages, the instructions being executable by the processor to cause the computing device to perform operations that include:
receiving a term occurrence search request at a text portion of the e-book content, the text portion comprising the term, the content of the e-book being apportioned according to a plurality of content apportionments;
determining a frequency of occurrence of the term within respective ones of the content apportionments;
rendering a frequency indicator of the frequency of occurrence associated with the respective ones of the content apportionments at the display screen;
receiving, at the display screen, a navigation request for transitioning to a selected one of the content apportionments of e-book content; and
displaying a summary list of term occurrence content excerpts from the selected content apportionment.

12. A computing device comprising:
a memory that stores a set of instructions and an e-book, e-book having content formatted according to a sequence of digitally constructed pages;
a display screen having touch functionality;
a processor that accesses the instructions in memory, the processor further configured to:
receive a term occurrence search request at a text portion of the e-book content, the text portion comprising the term, the content of the e-book being apportioned according to a plurality of content apportionments;
determine a frequency of occurrence of the term within respective ones of the content apportionments;
render a frequency indicator of the frequency of occurrence associated with the respective ones of the content apportionments at the display screen;
receive, at the display screen, a navigation request for transitioning to a selected one of the content apportionments of e-book content; and
display a summary list of term occurrence content excerpts from the selected content apportionment.

13. The computing device of claim 12 wherein the term occurrence content excerpts are selectable within the summary list.

14. The computing device of claim 13 wherein the processor is further configured to:
receive a selection of a respective one of the term occurrence content excerpts from the summary list; and
render the selected term occurrence content excerpt arranged intermediate an antecedent content portion and a subsequent content portion of the content apportionment.

15. The computing device of claim 12 wherein the term occurrence search request comprises a long press touch gesture enacted upon the term on the display screen.

16. The computing device of claim 12 wherein the term occurrence search request is received by way of a long press upon the term.

17. The computing device of claim 12 wherein the respective ones of the content apportionments comprise apportioned chapters of the e-book.

18. The computing device of claim 17 wherein the e-book is an e-magazine and the respective ones of the content apportionments comprise apportioned e-magazine articles.

19. The computing device of claim 12 wherein the summary list is scrollable to show the content excerpts in order of occurrence within the selected content apportionment.

20. The computing device of claim 12 wherein the term is rendered visually distinctly within at least one of the summary list and the selected content apportionment.
